(19) United States
(12) Patent Application Publication
(10) Pub. No.: US 2025/0254658 A1
(43) Pub. Date: Aug. 7, 2025

(54) PAGING TECHNOLOGIES FOR SMALL-DATA TRANSMISSIONS

(71) Applicant: Apple Inc., Cupertino, CA (US)

(72) Inventors: Fangli Xu, Beijing (CN); Alexander Sirotkin, Tel Aviv (IL); Haijing Hu, Los Gatos, CA (US); Naveen Kumar R. Palle Venkata, San Diego, CA (US); Pavan Nuggehalli, San Carlos, CA (US); Ralf Rossbach, Munich (DE); Sethuraman Gurumoorthy, San Ramon, CA (US); Srirang A. Lovlekar, Fremont, CA (US); Yuqin Chen, Beijing (CN)

(73) Assignee: Apple Inc., Cupertino, CA (US)

(21) Appl. No.: 18/856,044

(22) PCT Filed: Apr. 4, 2023
(86) PCT No.: PCT/US2023/017425

§ 371 Date: Oct. 10, 2024

Related U.S. Application Data
(60) Provisional application No. 63/331,252, filed on Apr. 14, 2022.

(51) Int. Cl. H04W 68/02; H04W 72/1273; H04W 72/232

(52) U.S. Cl. CPC H04W 68/02; H04W 72/1273; H04W 72/232

(57) ABSTRACT

The present application relates to devices and components including apparatuses, systems, and methods for paging technologies for mobile-terminated, small-data transmissions.

### CROSS REFERENCE TO RELATED APPLICATION

This application claims priority to U.S. Provisional Application No. 63/331,252, filed Apr. 14, 2022. The content of said application is hereby incorporated by reference in its entirety.

### FIELD

The present application relates to the field of wireless network and, in particular, to paging technologies for small-data transmissions.

### BACKGROUND

Third Generation Partnership Project (3GPP) Technical Specifications (TSs) define standards for wireless networks. One area of study for developing these TSs is with respect to managing small-data transmissions.

### BRIEF DESCRIPTION OF THE DRAWINGS

FIG. 1 illustrates a network environment in accordance with some embodiments.

FIG. 2 illustrates a mobile-terminated (MT)-small-data transmission (SDT) operation in accordance with some embodiments.

FIG. 3 illustrates a paging message in accordance with some embodiments.

FIG. 4 illustrates another paging message in accordance with some embodiments.

FIG. 5 illustrates another paging message in accordance with some embodiments.

FIG. 6 illustrates paging occasion configurations in accordance with some embodiments.

FIG. 7 illustrates a paging operation in accordance with some embodiments.

FIG. 8 illustrates an MT-SDT operation in accordance with some embodiments.

FIG. 9 illustrates an operational flow/algorithmic structure in accordance with some embodiments.

FIG. 10 illustrates an operational flow/algorithmic structure in accordance with some embodiments.

FIG. 11 illustrates an operational flow/algorithmic structure in accordance with some embodiments.

FIG. 12 illustrates a user equipment in accordance with some embodiments.

FIG. 13 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B).

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, or network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

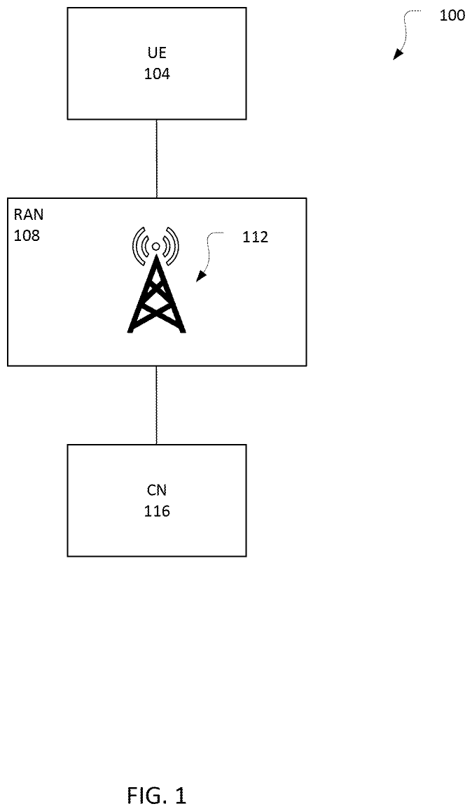

FIG. 1 illustrates a network environment 100 in accordance with some embodiments. The network environment 100 may include a UE 104 coupled with a radio access network (RAN) 108 that includes a base station (BS) 112. The UE 104 and the BS 112 may communicate over air interfaces compatible with 3GPP TSs such as those that define Fifth Generation System (5GS) (or later) standards. The BS 112 may be a next generation node B (gNB) to provide one or more New Radio (NR) cells that present NR user plane and control plane protocol terminations toward the UE 104.

The RAN 108 may be coupled with a core network (CN) 116. The CN 116 may have a variety of network functions that provide services such as storing subscription information, authenticating UEs/network components, registering and tracking UEs, managing quality of service (QOS) aspects, controlling data sessions, and forwarding uplink/downlink traffic.

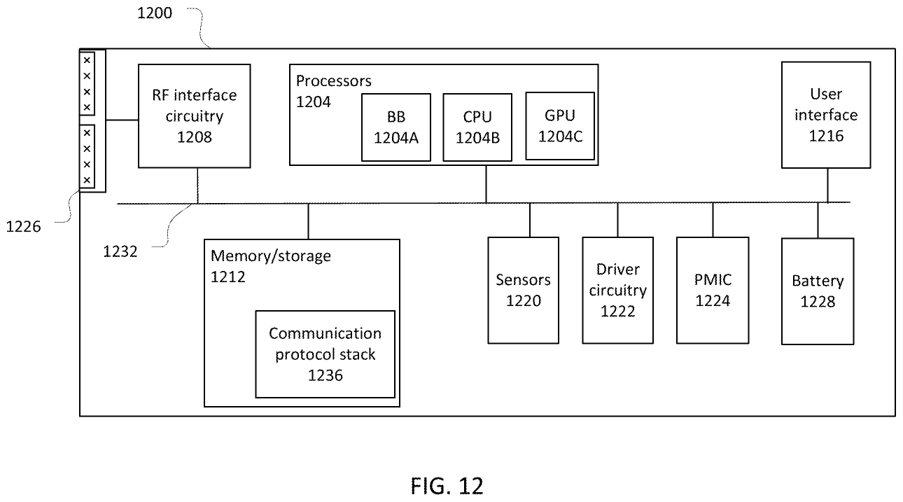

The UE 102 may include a radio resource control (RRC) state machine that perform operations related to a variety of RRC procedures including, for example, paging, RRC connection establishment, RRC connection reconfiguration, and RRC connection release. The RRC state machine may be implemented by protocol processing circuitry, see, for example, baseband processor circuitry 1204A of FIG. 12.

The RRC state machine may transition the UE 104 into one of a number of RRC states (or “modes”) including, for example, a connected state (RRC connected), an inactive state (RRC inactive), and an idle state (RRC idle). A UE may start in RRC idle when it first camps on an NR cell, which may be after the UE 104 is switched on or after an inter-system cell reselection from a Long Term Evolution (LTE) cell. To engage in active communications, the RRC state machine may transition the UE from RRC idle to RRC connected by performing an RRC setup procedure to establish a logical connection, for example, an RRC connection, with the RAN 108. In RRC connected, the UE may be configured with at least one signaling radio bearer (SRB) for signaling (for example, control messages) with the base station; and one or more data radio bearers (DRBs) for data transmission. When the UE is less actively engaged in network communications, the RRC state machine may transition the UE from RRC connected to RRC inactive using an RRC release procedure. The RRC inactive state may allow the UE 104 to reduce power consumption as compared to RRC connected, but will still allow the UE 104 to quickly transition back to RRC connected to transfer application data or signaling messages.

A network may transmit paging messages in order to reach UEs that are in RRC idle or RRC inactive states. Paging may also be used to notify UEs (in idle, inactive, or connected states) of changes to system information and earthquake and tsunami warning system (ETWS)/commercial mobile alert system (CMAS) indications through short messages.

Both paging messages and short messages may be addressed with paging-radio network temporary identity (P-RNTI) on the physical downlink control channel (PDCCH). The paging messages may be sent through the paging control channel (PCCH) while the short messages may be sent over the PDCCH directly.

The UE may monitor one paging occasion (PO) per paging discontinuous reception (DRX) cycle. A paging message may have a CN-initiated paging type or a RAN-initiated paging type. A CN-initiated paging type may be used to transition a UE from an idle state to a connected state with a 5G-shortened-temporary mobile subscriber identity (S-TMSI) UE identifier (ID) for paging reception. A CN-initiated paging type may have a paging DRX cycle equal to a minimum of [default cycle from system information block (SIB) or a UE specific cycle from non-access stratum (NAS) signaling]. A RAN-initiated paging type may be used to transition a UE from an inactive state to a connected state with an inactive-radio network temporary identity (I-RNTI) UE ID for paging reception. A RAN-initiated paging type may have a paging DRX cycle equal to a minimum of [default cycle from SIB, a UE-specific cycle from NAS signaling, or a RAN-specific cycle from an RRC signal].

A PO may be a set of PDCCH monitoring occasions and may include a plurality of timeslots in which a paging DCI (for example, a DCI that schedules a paging message) may be sent.

The UE 104 may determine a system frame number (SFN) for a paging frame (PF) based on the following:

$$( SFN + PF\_offset ) mod T = ( TdivN ) * ( UE\_ID mod N ) , \qquad Equation 1$$

where T is a DRX cycle of the UE 104, N is a number of total paging frames in T, PF_offset is an offset used for PF determination, and UE_ID is 5G-S-TMSI mod 1024.

An index (i_s) of a PO may be determined by:

$$i\_s = floor ( UE\_ID / N ) mode Ns , \qquad Equation 2$$

where Ns is a number of paging occasions for a PF. N, Ns, and PF_offset may be determined based on a PCCH configuration

A short message may be transmitted on PDCCH using P-RNTI with or without an associated paging message using a short message field in DCI format 1_0. A short message field may include eight bits with a first bit to provide a system information modification indication and a second bit to provide an ETWS or CMAS indication. The first bit may be set to ‘1’ to indicate a broadcast control channel modification other than SIB6, SIB7, and SIB8. The second bit may be set to ‘1’ to indicate an ETWS primary notification, an ETWS secondary notification, or a CMAS notification. The remaining bits are considered reserved bits in legacy networks.

A paging message may be transmitted by PCCH, which may be a physical downlink shared channel (PDSCH) transmission. One paging message may be used to notify up to 32 UEs.

Release 17 networks may utilize paging early indications (PEIs) in PDCCH transmissions to reduce UE power consumption due to false paging alarms. Each PO may be associated with a configured PEI occasion. A UE may belong to a paging subgroup that is configured by a CN or calculated based on a UE ID. The UE may monitor the PEI occasion that is associated with its PO. If the UE receives a PEI with that subgroup ID, the UE will start to monitor the PO.

In Release 16 and prior networks (for example, networks that implemented 3GPP TS Releases prior to Release 17), for uplink data arrival for an inactive UE, the UE would trigger an RRC resume procedure and enter the connected state for data transmission. For downlink data arrival for an inactive UE in these networks, the network would send a RAN paging message to request the UE transition back to the connected state for data transmission.

Release 17 networks may utilize mobile-originated (MO)-small-data transmission (SDT) procedures that allow an inactive UE, upon receipt of uplink data arrival of SDT resource blocks (RBs), to perform UL data transmission in the inactive state. Data to be transmitted may be considered SDT if a volume of the data is less than a predetermined threshold. This may reduce signaling overhead and UE power consumption by avoiding the transition to connected state and reducing latency by allowing fast transmission of small, and likely infrequent, packets that include, for example, positioning data. When downlink data arrives at a Release 17 network for a UE in an inactive state, the network may trigger RAN paging to request the UE transition back to the connected state. If the UE is in the process of an SDT procedure, and non-SDT data radio bearer (DRB) downlink data arrives at the network, the network may directly send an RRC resume message during the SDT procedure and request the UE transition back to the connected state.

However, for the downlink data arrival case, even for the small and infrequent data transmission, the UE has to transition back to the connected state for data reception. Providing mobile terminated (MT)-SDT procedures based on downlink-triggered SDT RBs may provide similar benefits to MO-SDT procedures. MT-SDT procedures may allow a network to send downlink data to a UE that is in an inactive state without requiring the UE to transition to the connected state.

As described above, the current purpose of UE-specific paging is to instruct a UE back to a connected state. Embodiments describe various paging technologies that may be used to trigger a UE to enter an MT-SDT procedure so that it may receive an SDT transmission while remaining in the inactive state.

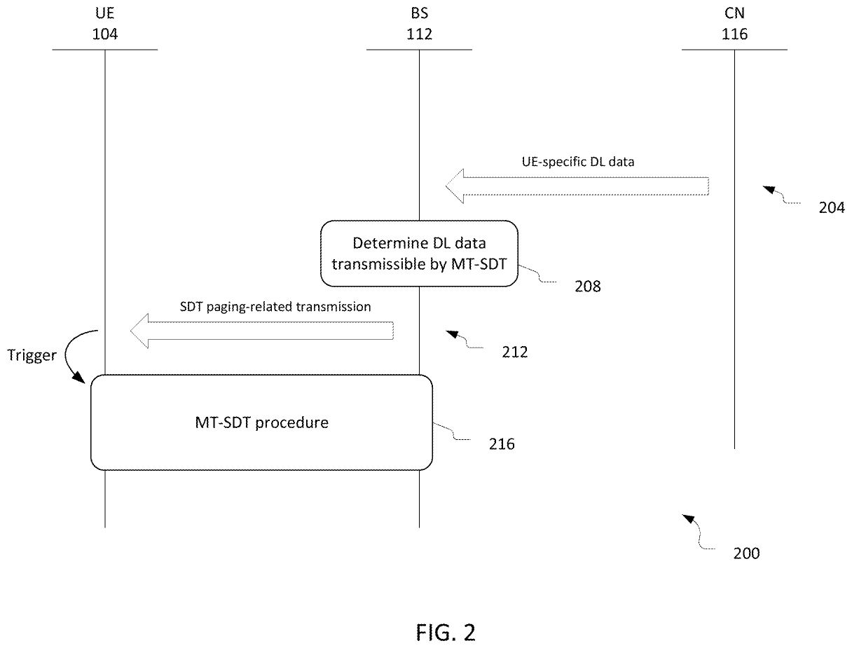

FIG. 2 illustrates an MT-SDT operation 200 in accordance with some embodiments.

The MT-SDT operation 200 may include, at 204, the BS 112 receiving UE-specific downlink data from the CN 116. The downlink data may be directed to the UE 104.

At 208, the BS 112 may determine that the downlink data is transmissible by MT-SDT. This determination may be based on an amount of data that is to be sent to the UE 104 or conditions of the channel over the air interface.

The MT-SDT operation 200 may further include the BS 112 generating and transmitting an SDT paging-related transmission to the UE 104 at 212. The SDT paging-related transmission may trigger the UE 104 to perform an MT-SDT procedure at 216. The MT-SDT procedure may include a number of operations that enable the UE 104 to receive the DL data in an MT-SDT. For example, the MT-SDT procedure 216 may involve the UE 104 monitoring a PDCCH to receive scheduling DCI that schedules downlink resources for the MT-SDT. For another example, the MT-SDT procedure 216 may involve the UE 104 transmitting a mobile-originated (MO)-SDT to the base station 112, which may then transmit the MT-SDT as a subsequent transmission. In some embodiments, the BS 112 may schedule UE-specific SDTs via a UE-specific cell-radio network temporary identity (C-RNTI), and the data transmission may be sent via an initial BWP of the current serving cell.

In some embodiments, the SDT paging-related transmission may be a paging message with an SDT indication that is to serve as the trigger for the UE 104.

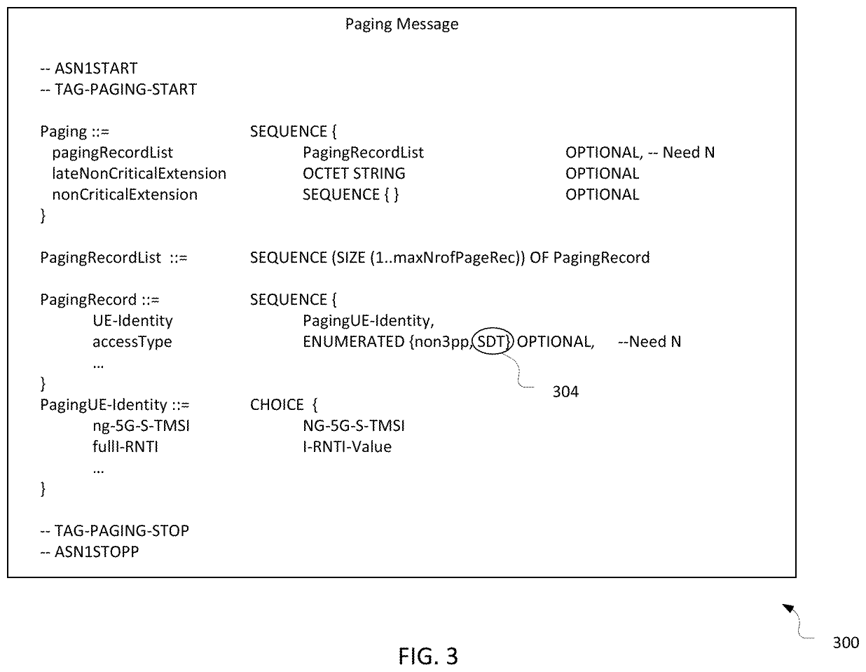

FIG. 3 illustrates abstract syntax notation 1 (ASN1) code for a paging message 300 in accordance with some embodiments. Except as otherwise described, the paging message 300 may be similar to a paging message as described in 3GPP TS 38.331 v16.7.0 (2021 December).

The paging message 300 may include a plurality of paging records within a paging record list. A paging record list may include up to a maximum number of paging records (maxNrof PageRec). Each paging record may be used to address a single UE.

A paging record of the paging message 300 may have an access type that is non-3GPP or SDT 304. The base station 112 may set the access type to non-3GPP to indicate that the paging message is originated due to a protocol data unit (PDU) session from non-3GPP access. The base station 112 may set the access type to SDT 304 to indicate that the paging message is for purposes of an MT-SDT transmission. Thus, the UE 104 may consider detection of the SDT access type 304 as the trigger to perform the MT-SDT procedure at 216.

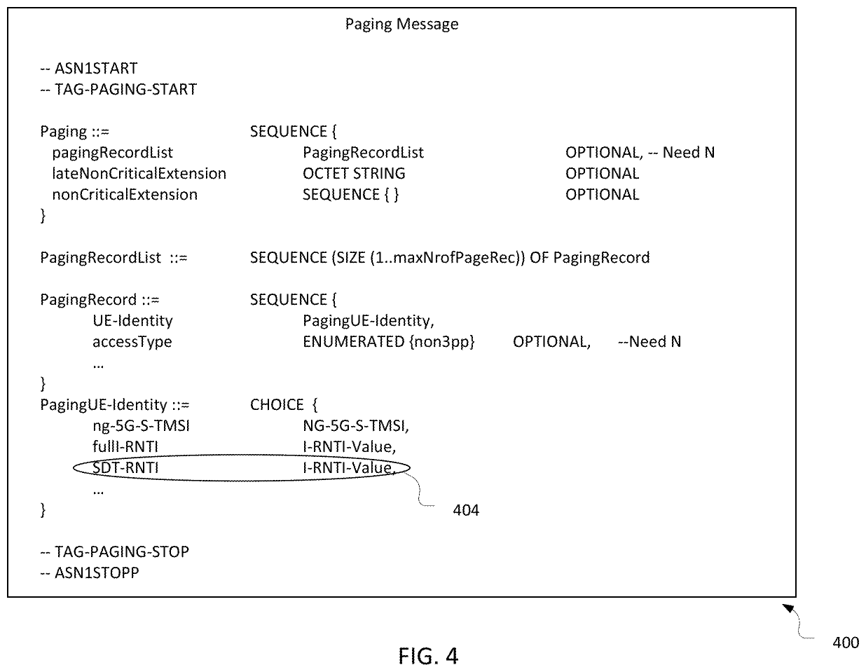

FIG. 4 illustrates ASN1 code for a paging message 400 in accordance with some embodiments. Except as otherwise described, the paging message 400 may be similar to a paging message as described in 3GPP TS 38.331 v16.7.0 (2021 December).

The paging message 400 may have, within a paging UE identity field, an SDT-RNTI 404. The SDT-RNTI 404, which may have an I-RNTI value, may indicate that the paging is for purposes of an MT-SDT transmission. Thus, the UE 104 may consider detection of the SDT-RNTI 404 as the trigger to perform the MT-SDT procedure at 216.

The network may explicitly configure the SDT-RNTI 404 together with the legacy I-RNTI (for example, the full I-RNTI) using RRC signaling. For example, this configuration may be done in an RRC release with suspend configuration message that the network uses to requests the UE to transition into the inactive state and enables the MT-SDT feature.

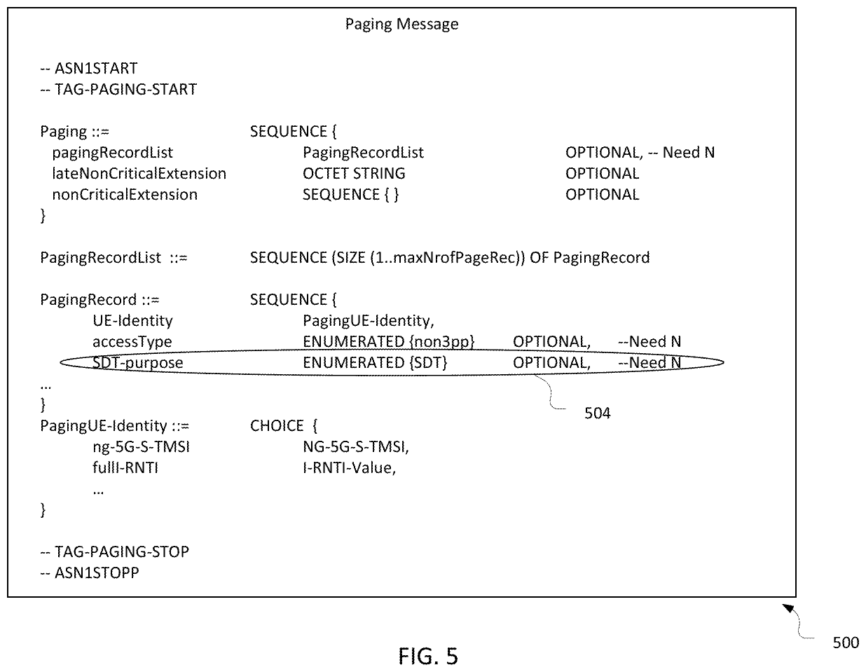

FIG. 5 illustrates ASN1 code for a paging message 500 in accordance with some embodiments. Except as otherwise described, the paging message 500 may be similar to a paging message as described in 3GPP TS 38.331 v16.7.0 (2021 December).

The paging message 500 may have, within the paging record field, an SDT purpose IE 504. The base station 112 may set the SDT purpose IE 504 to SDT to indicate that the paging message is for purposes of an MT-SDT transmission. Thus, the UE 104 may consider detection of the SDT purpose IE 504 set to SDT as the trigger to perform the MT-SDT procedure at 216.

In some embodiments, the SDT paging-related transmission 212 may be a DCI transmission that, for example, schedules a paging message. For example, the SDT paging-related transmission 212 may be a short message that is transmitted on PDCCH using P-RNTI with or without an associated paging message using the short message field in DCI format 1_0. In some embodiments, the short message transmission may include a bit (for example, the third bit) that is set to ‘1’ to indicate that the associated paging message is for purposes of an MT-SDT transmission. Thus, the UE 104 may consider detection of the third bit of the paging scheduling DCI set to ‘1’ as the trigger to perform the MT-SDT procedure at 216.

If the SDT indication is carried in a paging short message DCI, the network may use the scheduled paging message to provide the UE identity. The paging message in this instance may be similar to a legacy paging message and may not need an additional SDT indication.

In some embodiments, the SDT paging-related transmission 212 may be a PDCCH transmission that includes a PEI. The PEI may trigger the UE 104 to enter the MT-SDT procedure 216 by including a one-bit indication to indicate whether the associated paging message is for purposes of an MT-SDT transmission. Additionally/alternatively, a sub-group may be predefined/preconfigured for SDT purposes. For example, the UE 104 may be associated with a first sub-group for legacy paging purposes and a second sub-group for SDT purposes. If the UE 104 detects PEI with an ID of the first sub-group, the UE 104 may monitor the PO to detect a legacy paging message and proceed to transition to the RRC connected state after receiving the paging message. If, on the other hand, the UE 104 detects a PEI with an ID of the second sub-group, the UE 104 may determine the associated paging message is for purposes of the MT-SDT transmission. In this manner, the UE 104 may consider an SDT indication in the PEI (either through the dedicated bit or identification of the SDT sub-group) as the trigger to perform the MT-SDT procedure at 216.

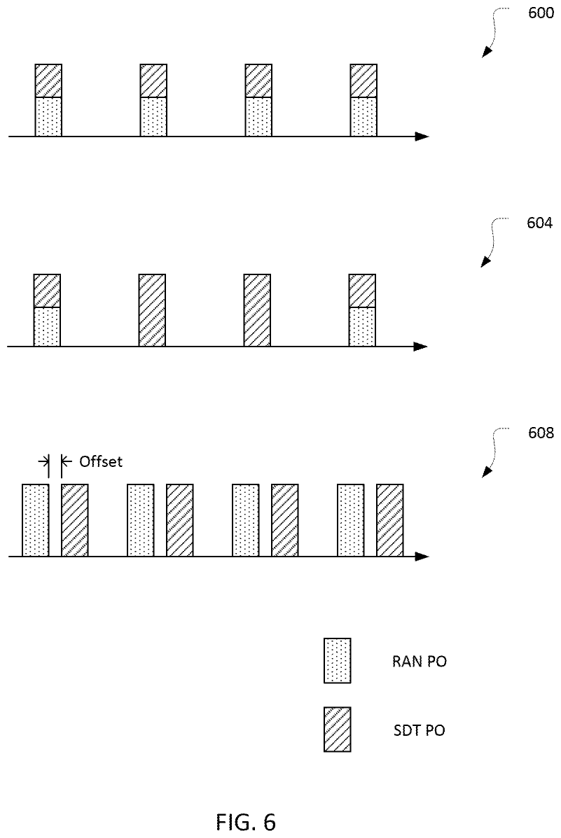

A PO used for DCI that schedules a RAN paging message may be referred to as a RAN PO, while a PO used for DCI that schedules an SDT paging message may be referred to as an SDT PO. FIG. 6 illustrates various PO configurations in accordance with some embodiments.

In PO configuration 600, the SDT POs and the RAN POs may fully overlap with one another. That is, the UE 104 may use the legacy method to determine the POs and use those POs for both RAN paging and SDT paging.

In PO configuration 604, the SDT POs may have an SDT-specific paging cycle. The SDT-specific paging cycle may be configured by the RAN 108 via a broadcast message such as a SIB or through a UE-dedicated configuration transmitted by RRC signaling. As shown, the initial SDT PO and RAN PO may overlap, but the SDT POs may have a paging cycle that is shorter than a paging cycle of the RAN POs. As shown, the RAN-specific paging cycle may be a multiple of the SDT-specific paging cycle. This may cause the RAN POs to partially overlap the SDT POs. The UE 104 may use the SDT paging cycle to derive the SDT POs that it will monitor for SDT paging messages.

While PO configuration 604 shows the SDT paging cycle as shorter than the RAN paging cycle, in other embodiments, the SDT paging cycle may be longer than the RAN paging cycle.

In PO configuration 608, the location of the SDT POs may be derived relative to the RAN POs. For example, the SDT POs may be set to follow the RAN POs by an offset in a time domain. The offset may be dynamically or statically configured or predefined by a 3GPP TS.

While PO configuration 608 shows the SDT POs following the RAN POs by the offset, other embodiments may have the SDT POs leading the RAN POs by the offset.

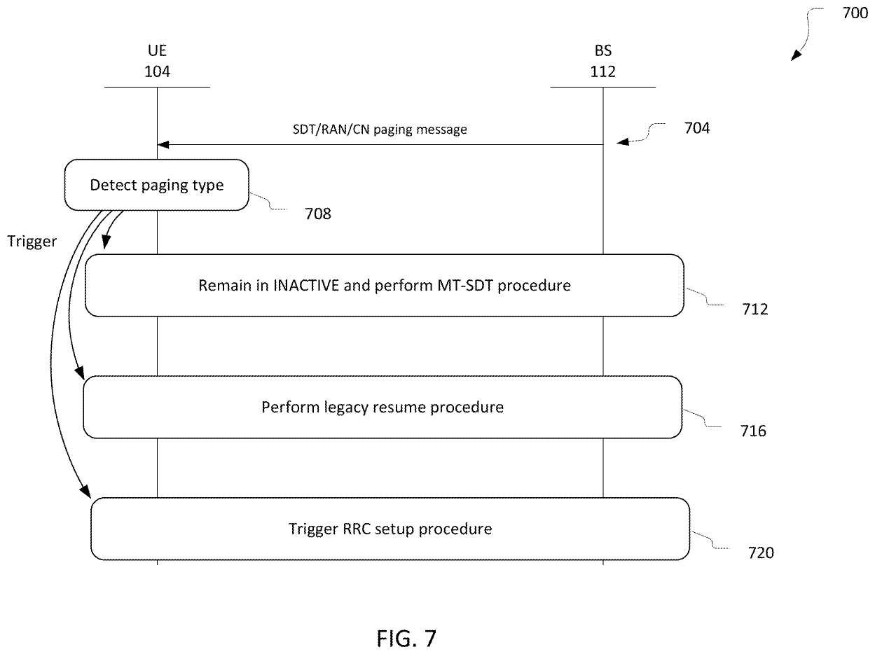

FIG. 7 illustrates a paging operation 700 in accordance with some embodiments.

At 704, the BS 112 may transmit a paging message to the UE 104. The UE 104 may be in an inactive or idle state. The paging message may be an SDT paging message, a RAN paging message, or a CN paging message.

At 708, the UE 104 may determine the paging type of the received paging message.

If the UE 104 determines the paging message is an SDT paging message at 708, the paging operation 700 may advance to 712 in which the UE 104 remains in an inactive state and performs an MT-SDT procedure. The MT-SDT procedure may be similar to MT-SDT procedure 216 discussed above with respect to FIG. 2.

If the UE 104 determines the paging message is a RAN paging message at 708, the paging operation 700 may advance to 716 in which the UE 104 performs a legacy resume procedure to transition from an inactive state to a connected state.

If the UE 104 determines the paging message is a CN paging message at 708, the paging operation 700 may advance to 720 in which the UE 104 performs an RRC setup procedure to transition from an idle state to a connected state. A non-access stratum (NAS) layer of the UE 104 may trigger the RRC setup procedure. If the UE 104 receives the CN paging message while in an inactive state, it may perform a go-to-idle operation by releasing an RRC connection and stored inactive context, and the NAS may release a NAS connection and trigger the RRC setup procedure and initiate the connection from the idle state.

In some instances, the UE 104 may receive a plurality of pages within one paging message. In this case, the UE 104 may prioritize the pages based on paging type. For example, in some embodiments, the UE 104 may assign a high priority to a CN page, a middle priority to a RAN page, and a low priority to an SDT page. Thus, a RAN page may be given priority over an SDT page, while a CN page may be given priority over both a RAN page and an SDT page.

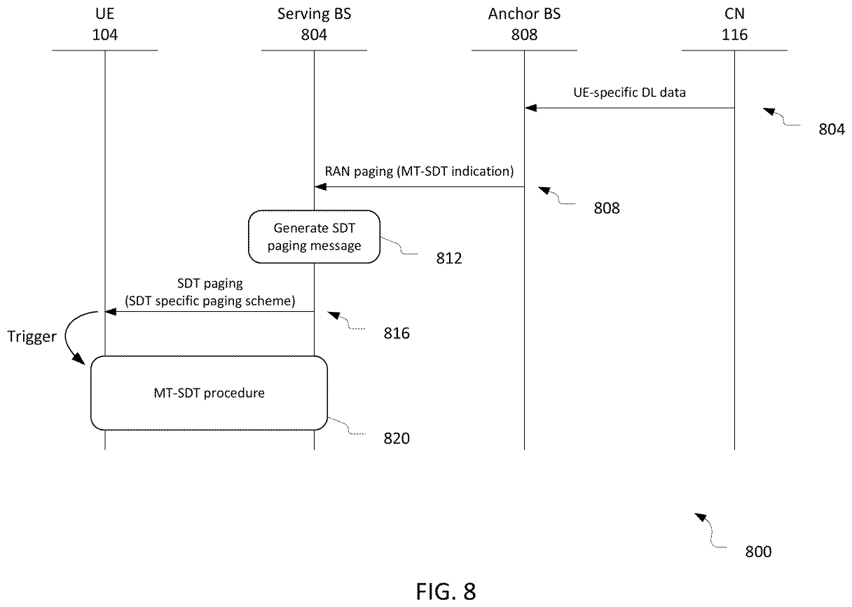

FIG. 8 illustrates an MT-SDT operation 800 in accordance with some embodiments. The MT-SDT operation 800 may be performed in association with a roaming event. For example, the UE 104 moves from a cell provided by an anchor BS 808 to a cell provided by serving BS 804 while in an inactive state. The serving BS 804 and the anchor BS 808 may be similar to the base station 112 described above with respect to FIG. 1.

The MT-SDT operation 800 may include the CN 116 providing the anchor BS 808 with UE-specific DL data. The DL data may be addressed to UE 104.

Upon receiving the DL data, the anchor BS 808 may determine the data is deliverable to the UE 104 by an MT-SDT procedure and may generate and transmit a RAN paging message. The RAN paging message may be forwarded to all serving BSs within an SDT RAN notification area (RNA).

In some embodiments, the RAN/anchor BS 808 may generate the SDT RNA and configure the SDT RNA to the UE 104. The UE 104 may use the configured SDT RNA to determine whether or not an SDT procedure is allowed. For example, if the UE 104 is camped on a cell of the SDT RNA, the UE 104 may initiate the SDT procedure. Else, the UE 104 may only perform the legacy RRC resume procedure. In other embodiments, the network may maintain the SDT RNA on the network-side without configuring it to the UE 104.

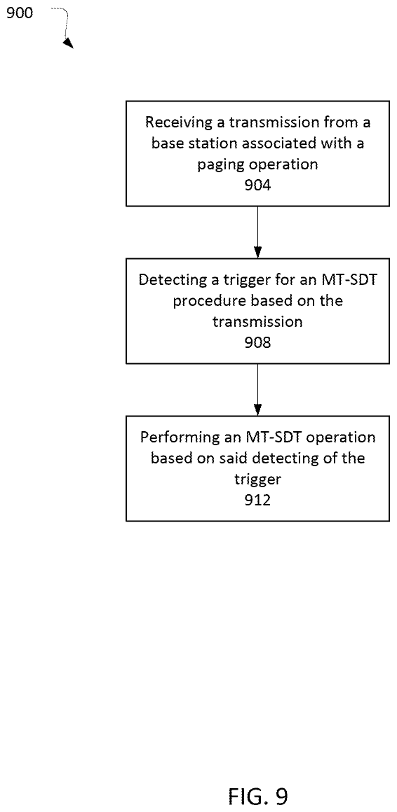

FIG. 9 illustrates an operation flow/algorithmic structure 900 in accordance with some embodiments. The operation flow/algorithmic structure 900 may be performed by a UE such as, for example, UE 104 or 1300, or components thereof, for example, processing circuitry 1304.

The operation flow/algorithmic structure 900 may include, at 904, receiving a transmission from a base station. The transmission may be associated with a paging operation. For example, the transmission may be a DCI that schedules a paging transmission, a PDCCH that includes a PEI, or the paging message itself.

The operation flow/algorithmic structure 900 may further include, at 908, detecting a trigger for an MT-SDT procedure based on the transmission. If the transmission is a paging message, detection of the trigger may be based on the paging message including an indication of an SDT access type; an SDT paging UE identity; or an SDT IE. If the transmission is a scheduling DCI, detection of the trigger may be based on presence of an SDT indication in a short message field. If transmission is a PDCCH with a PEI, detection of the trigger may be based on presence of an SDT indication in the PEI field or detection of a subgroup ID that is associated with a subgroup configured with an SDT purpose.

The operation flow/algorithmic structure 900 may further include, at 912, performing an MT-SDT operation based on detecting the trigger. The MT-SDT operation may be an operation of an MT-SDT procedure to enable receipt of a downlink transmission that includes MT-SDT data. This may include monitoring PDCCH for a DCI that schedules the downlink transmission or initiating an MO-SDT that may enable the downlink transmission as a subsequent transmission. The MO-SDT may be similar to that described in Change Requests (CRs) for Release 17 TSs as defined in R2-2204234—Introduction of SDT, 3GPP TSG-RAN WG2 Meeting #117 Electronic Elbonia, 21 Feb.-3 Mar. 2022; R2-2204216—Introduction of Small Data Transmission for MAC spec, 3GPP TSG-RAN2 Meeting #117e Electronic, 21 Feb.-3 Mar. 2022; and R2-2203768—Introduction of SDT, 3GPP TSG-RAN WG2 Meeting #117-e Electronic, 21 Feb.-3 Mar. 2022.

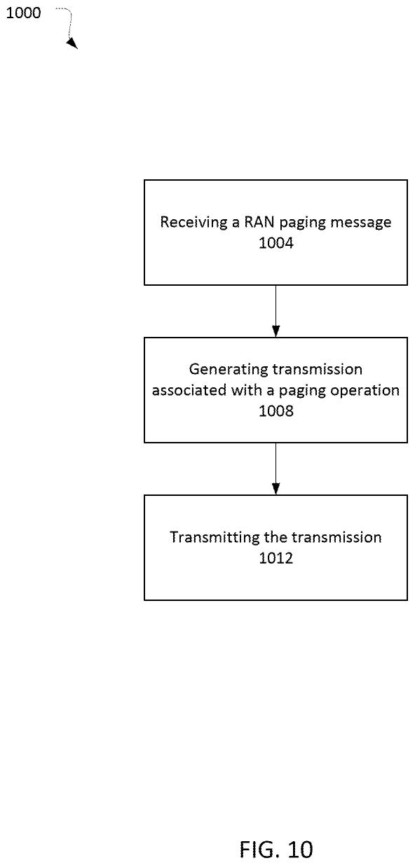

FIG. 10 illustrates an operation flow/algorithmic structure 1000 in accordance with some embodiments. The operation flow/algorithmic structure 1000 may be performed by a base station such as, for example, BS 112, serving BS 804, or network node 1300, or components thereof, for example, processing circuitry 1304.

The operation flow/algorithmic structure 1000 may include, at 1004, receiving a RAN paging message. The RAN paging message, which may be received from an anchor base station, may include an MT-SDT indication. The MT-SDT indication may indicate that the anchor base station has data to be transmitted to a UE through MT-SDT.

The operation flow/algorithmic structure 1000 may further include, at 1008, generating a transmission associated with the paging operation. The transmission may be a DCI that schedules a paging transmission, a PDCCH that includes a PEI, or the paging message itself.

The transmission may be generated to include an MT-SDT trigger. Similar to that discussed above, if the transmission is a paging message, the MT-SDT trigger may be an indication of an SDT access type, an indication of an SDT paging UE identity, or an SDT IE. If the transmission is a PDCCH transmission with a PEI field, the MT-SDT trigger may be an SDT indication in the PEI field. If the transmission is a scheduling DCI, the MT-SDT trigger may be an SDT indication in a short message field.

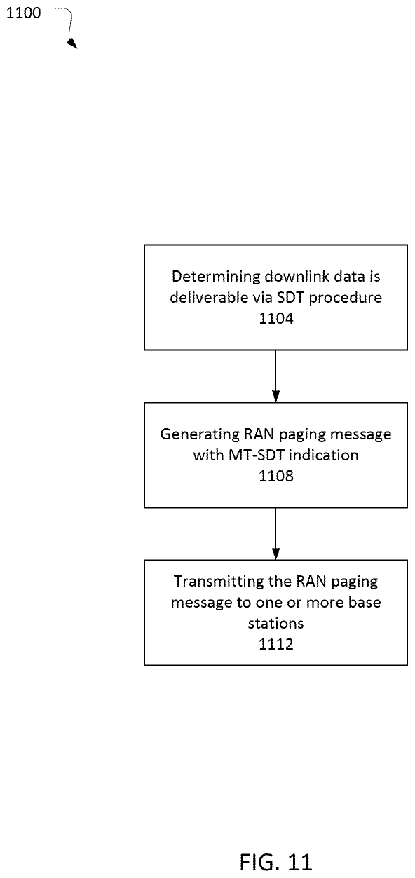

FIG. 11 illustrates an operation flow/algorithmic structure 1100 in accordance with some embodiments. The operation flow/algorithmic structure 1100 may be performed by a base station such as, for example, BS 112, anchor BS 808, or network node 1300, or components thereof, for example, processing circuitry 1304.

The operation flow/algorithmic structure 1100 may include, at 1104, determining downlink data for a UE is deliverable via an SDT procedure. The base station may make this determination based on an amount of data that is received or is expected to be received. In some embodiments, if the amount of data is less than a predetermined threshold, the base station may determine that it is capable of delivering the data via an MT-SDT procedure.

The operation flow/algorithmic structure 1100 may further include, at 1108, generating a RAN paging message with an MT-SDT indication. The MT-SDT indication may prompt a receiving base station to send a paging-related transmission over the Uu interface in a manner that triggers the UE to perform the MT-SDT operation to facilitate reception of the MT-SDT transmission. The RAN paging message may be generated for transmission over an Xn interface between the base stations.

The operation flow/algorithmic structure 1100 may further include, at 1112, transmitting the RAN paging message to one or more base stations. In some embodiments, the base station may transmit the RAN paging message to all serving base stations within an SDT-RNA.

FIG. 12 illustrates a UE 1200 in accordance with some embodiments. The UE 1200 may be similar to and substantially interchangeable with UE 124 of FIG. 1.

The UE 1200 may be any mobile or non-mobile computing device, such as, for example, mobile phones, computers, tablets, XR devices, glasses, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 1200 may include processors 1204, RF interface circuitry 1208, memory/storage 1212, user interface 1216, sensors 1220, driver circuitry 1222, power management integrated circuit (PMIC) 1224, antenna 1226, and battery 1228. The components of the UE 1200 may be implemented as integrated circuits (ICs), portions thereof, discrete electronic devices, or other modules, logic, hardware, software, firmware, or a combination thereof. The block diagram of FIG. 12 is intended to show a high-level view of some of the components of the UE 1200. However, some of the components shown may be omitted, additional components may be present, and different arrangement of the components shown may occur in other implementations.

The components of the UE 1200 may be coupled with various other components over one or more interconnects 1232, which may represent any type of interface, input/output, bus (local, system, or expansion), transmission line, trace, or optical connection that allows various circuit components (on common or different chips or chipsets) to interact with one another.

The processors 1204 may include processor circuitry such as, for example, baseband processor circuitry (BB) 1204A, central processor unit circuitry (CPU) 1204B, and graphics processor unit circuitry (GPU) 1204C. The processors 1204 may include any type of circuitry or processor circuitry that executes or otherwise operates computer-executable instructions, such as program code, software modules, or functional processes from memory/storage 1212 to cause the UE 1200 to perform operations as described herein.

In some embodiments, the baseband processor circuitry 1204A may access a communication protocol stack 1236 in the memory/storage 1212 to communicate over a 3GPP compatible network. In general, the baseband processor circuitry 1204A may access the communication protocol stack 1236 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 1208.

The baseband processor circuitry 1204A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1212 may include one or more non-transitory, computer-readable media that includes instructions (for example, communication protocol stack 1236) that may be executed by one or more of the processors 1204 to cause the UE 1200 to perform various operations described herein. The memory/storage 1212 include any type of volatile or non-volatile memory that may be distributed throughout the UE 1200. In some embodiments, some of the memory/storage 1212 may be located on the processors 1204 themselves (for example, L1 and L2 cache), while other memory/storage 1212 is external to the processors 1204 but accessible thereto via a memory interface. The memory/storage 1212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1208 may include transceiver circuitry and radio frequency front module (RFEM) that allows the UE 1200 to communicate with other devices over a radio access network. The RF interface circuitry 1208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1226 and proceed to filter and amplify (with a low-noise amplifier) the signal. The signal may be provided to a receiver of the transceiver that down-converts the RF signal into a baseband signal that is provided to the baseband processor of the processors 1204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1226.

In various embodiments, the RF interface circuitry 1208 may be configured to transmit/receive signals in a manner compatible with NR access technologies.

The antenna 1226 may include antenna elements to convert electrical signals into radio waves to travel through the air and to convert received radio waves into electrical signals. The antenna elements may be arranged into one or more antenna panels. The antenna 1226 may have antenna panels that are omnidirectional, directional, or a combination thereof to enable beamforming and multiple input, multiple output communications. The antenna 1226 may include microstrip antennas, printed antennas fabricated on the surface of one or more printed circuit boards, patch antennas, or phased array antennas. The antenna 1226 may have one or more panels designed for specific frequency bands including bands in FR1 or FR2.

The user interface 1216 includes various input/output (I/O) devices designed to enable user interaction with the UE 1200. The user interface 1216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1200.

The sensors 1220 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1222 may include software and hardware elements that operate to control particular devices that are embedded in the UE 1200, attached to the UE 1200, or otherwise communicatively coupled with the UE 1200. The driver circuitry 1222 may include individual drivers allowing other components to interact with or control various I/O devices that may be present within, or connected to, the UE 1200. For example, the driver circuitry 1222 may include circuitry to facilitate coupling of a UICC (for example, UICC 148) to the UE 1200. For additional examples, driver circuitry 1222 may include a display driver to control and allow access to a display device, a touchscreen driver to control and allow access to a touchscreen interface, sensor drivers to obtain sensor readings of the sensors 1220 and control and allow access to sensors 1220, drivers to obtain actuator positions of electro-mechanic components or control and allow access to the electro-mechanic components, a camera driver to control and allow access to an embedded image capture device, audio drivers to control and allow access to one or more audio devices.

The PMIC 1224 may manage power provided to various components of the UE 1200. In particular, with respect to the processors 1204, the PMIC 1224 may control power-source selection, voltage scaling, battery charging, or DC-to-DC conversion.

In some embodiments, the PMIC 1224 may control, or otherwise be part of, various power saving mechanisms of the UE 1200 including DRX as discussed herein.

A battery 1228 may power the UE 1200, although in some examples the UE 1200 may be mounted deployed in a fixed location, and may have a power supply coupled to an electrical grid. The battery 1228 may be a lithium ion battery, a metal-air battery, such as a zinc-air battery, an aluminum-air battery, a lithium-air battery, and the like. In some implementations, such as in vehicle-based applications, the battery 1228 may be a typical lead-acid automotive battery.

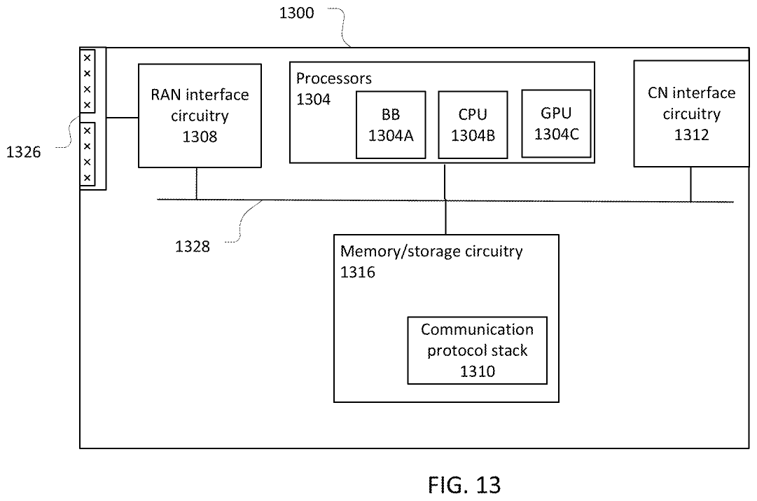

FIG. 13 illustrates a network node 1300 in accordance with some embodiments. The network node 1300 may be similar to and substantially interchangeable with base station 132, serving BS 804, or anchor BS 808.

The network node 1300 may include processing circuitry 1304, RF interface circuitry 1308 (if implemented as an access node), core network (CN) interface circuitry 1312, memory/storage circuitry 1316, and antenna structure 1326.

The components of the network node 1300 may be coupled with various other components over one or more interconnects 1328.

The processor circuitry 1304, RF interface circuitry 1308, memory/storage circuitry 1316 (including communication protocol stack 1310), antenna structure 1326, and interconnects 1328 may be similar to like-named elements shown and described with respect to FIG. 12.

The CN interface circuitry 1312 may provide connectivity to a core network, for example, a 5th Generation Core network (5GC) using a 5GC-compatible network interface protocol such as carrier Ethernet protocols, or some other suitable protocol. Network connectivity may be provided to/from the network node 1300 via a fiber optic or wireless backhaul. The CN interface circuitry 1312 may include one or more dedicated processors or FPGAs to communicate using one or more of the aforementioned protocols. In some implementations, the CN interface circuitry 1312 may include multiple controllers to provide connectivity to other networks using the same or different protocols.

In some embodiments, the network node 1300 may be coupled with transmit receive points (TRPs) using the antenna structure 1326, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method of operating a user equipment (UE), the method comprising: receiving a transmission from a base station, the transmission associated with a paging operation; detecting a trigger for a mobile-terminated (MT)-small-data transmission (SDT) procedure based on the transmission received from the base station; and performing an MT-SDT operation based on said detecting of the trigger.

Example 2 includes method of example 1 or some other example herein, wherein the transmission is a paging message.

Example 3 includes method of example 2 or some other example herein, wherein the paging message comprises an indication of an SDT access type and the method further comprises: detecting the trigger for the MT-SDT based on the indication of the SDT access type.

Example 4 includes a method of example 2 or some other example herein, wherein the paging message comprises an indication of an SDT paging UE identity and the method further comprises: detecting the trigger for the MT-SDT based on the indication of the SDT paging UE identity.

Example 5 includes a method of example 4 some other example herein, wherein the SDT paging UE identity comprises an inactive-radio network temporary identity (I-RNTI) value.

Example 6 includes the method of example 2 or some other example herein, wherein the paging message comprises a paging record with an SDT information element (IE) and the method further comprises: detecting the trigger for the MT-SDT based on the SDT IE.

Example 7 includes the method of example 1 or some other example herein, wherein the transmission is a downlink control information (DCI) transmission that schedules a paging message.

Example 8 includes method of example 7 or some other example herein, wherein the DCI transmission includes a short message field with an SDT indication and the method further comprises: detecting the trigger for the MT-SDT procedure based on the SDT indication.

Example 9 includes the method of example 1 or some other example herein, wherein the transmission is a physical downlink control channel (PDCCH) transmission that includes a paging early indication (PEI) field with an SDT indication and the method further comprises: detecting the trigger for the MT-SDT procedure based on the SDT indication.

Example 10 includes a method of example 1 or some other example herein, wherein the transmission is a physical downlink control channel (PDCCH) transmission that includes a paging early indication (PEI) field with a subgroup ID that is associated with a subgroup configured with an SDT purpose and the method further comprises: detecting the trigger for the MT-SDT procedure based on the subgroup ID.

Example 11 includes the method of example 1 or some other example herein, further comprising: monitoring an SDT paging occasion; and receiving the transmission based on said monitoring.

Example 12 includes a method of example 11 or some other example herein, wherein the one or more SDT paging occasions fully or partially overlap one or more RAN paging occasions.

Example 13 includes a method of example 11 or some other example herein, wherein the one or more SDT paging occasions are respectively offset from one or more RAN paging occasions by a predetermined amount in a time-domain.

Example 14 includes a method of operating a serving base station, the method comprising: receiving, from an anchor base station, a radio access network (RAN) paging message with a mobile terminated (MT)-small data transmission (SDT) indication; generating, based on the RAN paging message with the MT-SDT indication, a transmission associated with a paging operation, the transmission to include an MT-SDT trigger; and transmitting the transmission to a user equipment (UE).

Example 15 includes the method of example 14 or some other example herein, wherein the transmission is a paging message.

Example 16 includes method of example 15 or some other example herein, wherein the MT-SDT trigger comprises an indication of an SDT access type; an indication of an SDT paging UE identity; or an SDT information element (IE).

Example 17 includes a method of example 15 or some other example herein, wherein the transmission is a downlink control information (DCI) transmission that schedules a paging message.

Example 18 includes the method of example 17 or some other example herein, wherein the trigger comprises a short message field with an SDT indication within the DCI transmission.

Example 19 includes the method of example 15 or some other example herein, wherein the transmission is a physical downlink control channel (PDCCH) transmission and the trigger comprises a paging early indication (PEI) field with an SDT indication within the PDCCH transmission.

Example 20 includes a method of operating a first base station, the method comprising: receiving downlink data for a user equipment (UE); determining the downlink data is deliverable via a small data transmission (SDT) procedure; generating a radio access network (RAN) paging message with a mobile terminated (MT)-SDT indication based on said determining; and transmitting the RAN paging message to a second base station.

Example 21 includes the method of example 20 or some other example herein, wherein an SDT RAN notification area (RNA) includes a plurality of base stations and the method further comprises: transmitting the RAN paging message to the plurality of base stations.

Example 22 may include an apparatus comprising means to perform one or more elements of a method described in or related to any of examples 1-21, or any other method or process described herein.

Example 23 may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Example 24 may include an apparatus comprising logic, modules, or circuitry to perform one or more elements of a method described in or related to any of examples 1-21, or any other method or process described herein.

Example 25 may include a method, technique, or process as described in or related to any of examples 1-21, or portions or parts thereof.

Example 26 may include an apparatus comprising: one or more processors and one or more computer-readable media comprising instructions that, when executed by the one or more processors, cause the one or more processors to perform the method, techniques, or process as described in or related to any of examples 1-21, or portions thereof.

Example 27 may include a signal as described in or related to any of examples 1-21, or portions or parts thereof.

Example 28 may include a datagram, information element, packet, frame, segment, PDU, or message as described in or related to any of examples 1-21, or portions or parts thereof, or otherwise described in the present disclosure.

Example 29 may include a signal encoded with data as described in or related to any of examples 1-21, or portions or parts thereof, or otherwise described in the present disclosure.

Example 30 may include a signal encoded with a datagram, IE, packet, frame, segment, PDU, or message as described in or related to any of examples 1-21, or portions or parts thereof, or otherwise described in the present disclosure.

Example 31 may include an electromagnetic signal carrying computer-readable instructions, wherein execution of the computer-readable instructions by one or more processors is to cause the one or more processors to perform the method, techniques, or process as described in or related to any of examples 1-21, or portions thereof.

Example 32 may include a computer program comprising instructions, wherein execution of the program by a processing element is to cause the processing element to carry out the method, techniques, or process as described in or related to any of examples 1-21, or portions thereof.

Example 33 may include a signal in a wireless network as shown and described herein.

Example 34 may include a method of communicating in a wireless network as shown and described herein.

Example 35 may include a system for providing wireless communication as shown and described herein.

Example 36 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1.-21. (canceled)

22. One or more non-transitory computer-readable media having instructions that, when executed, cause processing circuitry to:
receive a transmission from a base station, the transmission associated with a paging operation;
detect a trigger for a mobile-terminated (MT)-small-data transmission (SDT) procedure based on the transmission received from the base station; and
perform an MT-SDT operation based on said detecting of the trigger.

23. The one or more non-transitory computer-readable media of claim 22, wherein the transmission is a paging message.

24. The one or more non-transitory computer-readable media of claim 23, wherein the paging message comprises an indication of an SDT access type and the instructions, when executed, further cause the processing circuitry to:
detect the trigger for the MT-SDT procedure based on the indication of the SDT access type.

25. The one or more non-transitory computer-readable media of claim 23, wherein the paging message comprises an indication of an SDT paging user equipment (UE) identity and the instructions, when executed, further cause the processing circuitry to:
detect the trigger for the MT-SDT procedure based on the indication of the SDT paging UE identity.

26. The one or more non-transitory computer-readable media of claim 25, wherein the SDT paging UE identity comprises an inactive-radio network temporary identity (I-RNTI) value.

27. The one or more non-transitory computer-readable media of claim 23, wherein the paging message comprises a paging record with an SDT information element (IE) and the instructions, when executed, further cause the processing circuitry to:
detect the trigger for the MT-SDT procedure based on the SDT IE.

28. The one or more non-transitory computer-readable media of claim 22, wherein the transmission is a downlink control information (DCI) transmission that schedules a paging message.

29. The one or more non-transitory computer-readable media of claim 28, wherein the DCI transmission includes a short message field with an SDT indication and the instructions, when executed, further cause the processing circuitry to:
detect the trigger for the MT-SDT procedure based on the SDT indication.

30. The one or more non-transitory computer-readable media of claim 22, wherein the transmission is a physical downlink control channel (PDCCH) transmission that includes a paging early indication (PEI) field with an SDT indication and the instructions, when executed, further cause the processing circuitry to:
detect the trigger for the MT-SDT procedure based on the SDT indication.

31. The one or more non-transitory computer-readable media of claim 22, wherein the transmission is a physical downlink control channel (PDCCH) transmission that includes a paging early indication (PEI) field with a subgroup ID that is associated with a subgroup configured with an SDT purpose and the instructions, when executed, further cause the processing circuitry to:
detect the trigger for the MT-SDT procedure based on the subgroup ID.

32. The one or more non-transitory computer-readable media of claim 22, wherein the instructions, when executed, further cause the processing circuitry to:
monitor an SDT paging occasion; and
receive the transmission based on said monitoring.

33. The one or more non-transitory computer-readable media of claim 32, wherein:
the one or more SDT paging occasions fully or partially overlap one or more RAN paging occasions; or
the one or more SDT paging occasions are respectively offset from one or more RAN paging occasions by a predetermined amount in a time-domain.

34. A method comprising:
receiving, from an anchor base station, a radio access network (RAN) paging message with a mobile terminated (MT)-small data transmission (SDT) indication;
generating, based on the RAN paging message with the MT-SDT indication, a transmission associated with a paging operation, the transmission to include an MT-SDT trigger; and
outputting the transmission for transmission to a user equipment (UE).

35. The method of claim 34, wherein the transmission is a paging message.

36. The method of claim 35, wherein the MT-SDT trigger comprises an indication of an SDT access type; an indication of an SDT paging UE identity; or an SDT information element (IE).

37. The method of claim 35, wherein the transmission is a downlink control information (DCI) transmission that schedules a paging message.

38. The method of claim 37, wherein the MT-SDT trigger comprises a short message field within the DCI transmission, wherein the short message field includes an SDT indication.

39. The method of claim 35, wherein the transmission is a physical downlink control channel (PDCCH) transmission and the MT-SDT trigger comprises a paging early indication (PEI) field within the PDCCH transmission, wherein the PEI field includes an SDT indication.

40. An apparatus comprising:
interface circuitry to receive downlink data for a user equipment (UE);
processing circuitry coupled with the interface circuitry, the processing circuitry to:
determine the downlink data is deliverable via a small data transmission (SDT) procedure;
generate a radio access network (RAN) paging message with a mobile terminated (MT)-SDT indication based on said determining; and
output, via the interface circuitry, the RAN paging message for transmission to a base station.

41. The apparatus of claim 40, wherein an SDT RAN notification area (RNA) includes a plurality of base stations and the processing circuitry is to output the RAN paging message for transmission to the plurality of base stations.
